(19) United States
(12) Patent Application Publication
(10) Pub. No.: US 2024/0171361 A1
(43) Pub. Date: May 23, 2024

(54) RADIO LINK MONITORING REFERENCE SIGNAL SELECTION

(71) Applicant: QUALCOMM Incorporated, San Diego, CA (US)

(72) Inventors: Fang YUAN, Beijing (CN); Muhammad Sayed Khairy ABDELGHAFFAR, San Jose, CA (US); Mostafa KHOSHNEVISAN, San Diego, CA (US); Yan ZHOU, San Diego, CA (US); Tao LUO, San Diego, CA (US)

(21) Appl. No.: 18/550,811

(22) PCT Filed: May 31, 2021
(86) PCT No.: PCT/CN21/97131

§ 371 Date: Sep. 15, 2023

(51) Int. Cl. H04L 5/00

(52) U.S. Cl. CPC H04L 5/0094; H04L 5/0053

(57) ABSTRACT

Various aspects of the present disclosure generally relate to wireless communication. In some aspects, a user equipment (UE) may select a set of radio link monitoring (RLM) reference signals according to a rule for selecting the set of RLM reference signals from among RLM reference signals that are quasi-colocated (QCLed) with active transmission control indicator (TCI) states for physical downlink control channel (PDCCH) communications in one or more control resource sets (CORESETs). The one or more CORESETs may include at least one CORESET with at least two active TCI states. The UE may monitor for the set of RLM reference signals. Numerous other aspects are described.

### FIELD OF THE DISCLOSURE

Aspects of the present disclosure generally relate to wireless communication and to techniques and apparatuses for selecting radio link monitoring reference signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes selecting a set of radio link monitoring (RLM) reference signals according to a rule for selecting the set of RLM reference signals from among RLM reference signals that are quasi-colocated (QCLed) with active transmission control indicator (TCI) states for physical downlink control channel (PDCCH) communications in one or more control resource sets (CORESETs). The one or more CORESETs may include at least one CORESET with at least two active TCI states. The method may include monitoring for the set of RLM reference signals.

In some aspects, a method of wireless communication performed by a UE includes selecting a set of RLM reference signals according to a rule for selecting the set of RLM reference signals from among RLM reference signals that are QCLed with active TCI states for PDCCH communications in CORESETs. The at least one of the PDCCH communications is to be monitored in two linked search space (SS) sets associated with two CORESETs of the CORESETs. The method includes monitoring for the set of RLM reference signals.

In some aspects, a method of wireless communication performed by a UE includes selecting a set of RLM reference signals according to a rule for selecting the set of RLM reference signals from among RLM reference signals that are QCLed with active TCI states for PDCCH communications in CORESETs. The at least two of the RLM reference signals that are QCLed with active TCI states in CORESETs may be associated with PDCCH repetition, and the at least two of the RLM reference signals may be associated with SS sets having a same monitoring periodicity. The method may include monitoring for the set of RLM reference signals.

In some aspects, a method of wireless communication performed by a base station includes generating an indication of a set of RLM reference signals that a UE is to monitor from among RLM reference signals that are QCLed with active TCI states for PDCCH communications in CORESETs. The at least one of the PDCCH communications may be associated with at least two active TCI states. The method may include transmitting the indication to the UE.

In some aspects, a UE for wireless communication includes a memory and one or more processors, coupled to the memory, configured to select a set of RLM reference signals according to a rule for selecting the set of RLM reference signals from among RLM reference signals that are QCLed with active TCI states for physical downlink control channel communications in one or more CORESETs, where the one or more CORESETs include at least one CORESET with at least two active TCI states, and monitor for the set of RLM reference signals.

In some aspects, a UE for wireless communication includes a memory and one or more processors, coupled to the memory, configured to select a set of RLM reference signals according to a rule for selecting the set of RLM reference signals from among RLM reference signals that are QCLed with active TCI states for PDCCH communications in CORESETs, where at least one of the PDCCH communications is to be monitored in two linked SS sets associated with two CORESETs of the CORESETs, and monitor for the set of RLM reference signals.

In some aspects, a UE for wireless communication includes a memory and one or more processors, coupled to the memory, configured to select a set of RLM reference signals according to a rule for selecting the set of RLM reference signals from among RLM reference signals that are QCLed with active TCI states for PDCCH communications in CORESETs. The at least two of the RLM reference signals that are QCLed with active TCI states in CORESETs may be associated with PDCCH repetition, and the at least two of the RLM reference signals may be associated with SS sets having a same monitoring periodicity. The one or more processors may be configured to monitor for the set of RLM reference signals.

In some aspects, a base station for wireless communication includes a memory and one or more processors, coupled to the memory, configured to generate an indication of a set of RLM reference signals that a UE is to monitor from among RLM reference signals that are QCLed with active TCI states for PDCCH communications in CORESETs, where at least one of the PDCCH communications is associated with at least two active TCI states, and transmit the indication to the UE.

In some aspects, a non-transitory computer-readable medium storing a set of instructions for wireless communication includes one or more instructions that, when executed by one or more processors of a UE, cause the UE to select a set of RLM reference signals according to a rule for selecting the set of RLM reference signals from among RLM reference signals that are QCLed with active TCI states for physical downlink control channel communications in one or more CORESETs, where the one or more CORESETs include at least one CORESET with at least two active TCI states, and monitor for the set of RLM reference signals.

In some aspects, a non-transitory computer-readable medium storing a set of instructions for wireless communication includes one or more instructions that, when executed by one or more processors of a UE, cause the UE to select a set of RLM reference signals according to a rule for selecting the set of RLM reference signals from among RLM reference signals that are QCLed with active TCI states for PDCCH communications in CORESETs, where at least one of the PDCCH communications is to be monitored in two linked SS sets associated with two CORESETs of the CORESETs, and monitor for the set of RLM reference signals.

In some aspects, a non-transitory computer-readable medium storing a set of instructions for wireless communication includes one or more instructions that, when executed by one or more processors of a UE, cause the UE to select a set of RLM reference signals according to a rule for selecting the set of RLM reference signals from among RLM reference signals that are QCLed with active TCI states for PDCCH communications in CORESETs, where at least two of the RLM reference signals that are QCLed with active TCI states in CORESETs are associated with PDCCH repetition, and where the at least two of the RLM reference signals are associated with SS sets having a same monitoring periodicity, and monitor for the set of RLM reference signals.

In some aspects, a non-transitory computer-readable medium storing a set of instructions for wireless communication includes one or more instructions that, when executed by one or more processors of a base station, cause the base station to generate an indication of a set of RLM reference signals that a UE is to monitor from among RLM reference signals that are QCLed with active TCI states for PDCCH communications in CORESETs, where at least one of the PDCCH communications is associated with at least two active TCI states, and transmit the indication to the UE.

In some aspects, an apparatus for wireless communication includes means for selecting a set of RLM reference signals according to a rule for selecting the set of RLM reference signals from among RLM reference signals that are QCLed with active TCI states for physical downlink control channel communications in one or more CORESETs, where the one or more CORESETs include at least one CORESET with at least two active TCI states, and means for monitoring for the set of RLM reference signals.

In some aspects, an apparatus for wireless communication includes means for selecting a set of RLM reference signals according to a rule for selecting the set of RLM reference signals from among RLM reference signals that are QCLed with active TCI states for PDCCH communications in CORESETs, where at least one of the PDCCH communications is to be monitored in two linked SS sets associated with two CORESETs of the CORESETs, and means for monitoring for the set of RLM reference signals.

In some aspects, an apparatus for wireless communication includes means for selecting a set of RLM reference signals according to a rule for selecting the set of RLM reference signals from among RLM reference signals that are QCLed with active TCI states for PDCCH communications in CORESETs, where at least two of the RLM reference signals that are QCLed with active TCI states in CORESETs are associated with PDCCH repetition, and where the at least two of the RLM reference signals are associated with SS sets having a same monitoring periodicity, and means for monitoring for the set of RLM reference signals.

In some aspects, an apparatus for wireless communication includes means for generating an indication of a set of RLM reference signals that a UE is to monitor from among RLM reference signals that are QCLed with active TCI states for PDCCH communications in CORESETs, where at least one of the PDCCH communications is associated with at least two active TCI states, and means for transmitting the indication to the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example resource structure for wireless communication, in accordance with the present disclosure.

FIG. 4 is a diagram illustrating an example of selecting reference signals for radio link monitoring (RLM), in accordance with the present disclosure.

FIG. 5 is a diagram illustrating an example process performed, for example, by a UE, in accordance with the present disclosure.

FIG. 6 is a diagram illustrating an example process performed, for example, by a UE, in accordance with the present disclosure.

FIG. 7 is a diagram illustrating an example process performed, for example, by a UE, in accordance with the present disclosure.

FIG. 8 is a diagram illustrating an example process performed, for example, by a base station, in accordance with the present disclosure.

FIGS. 9-12 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

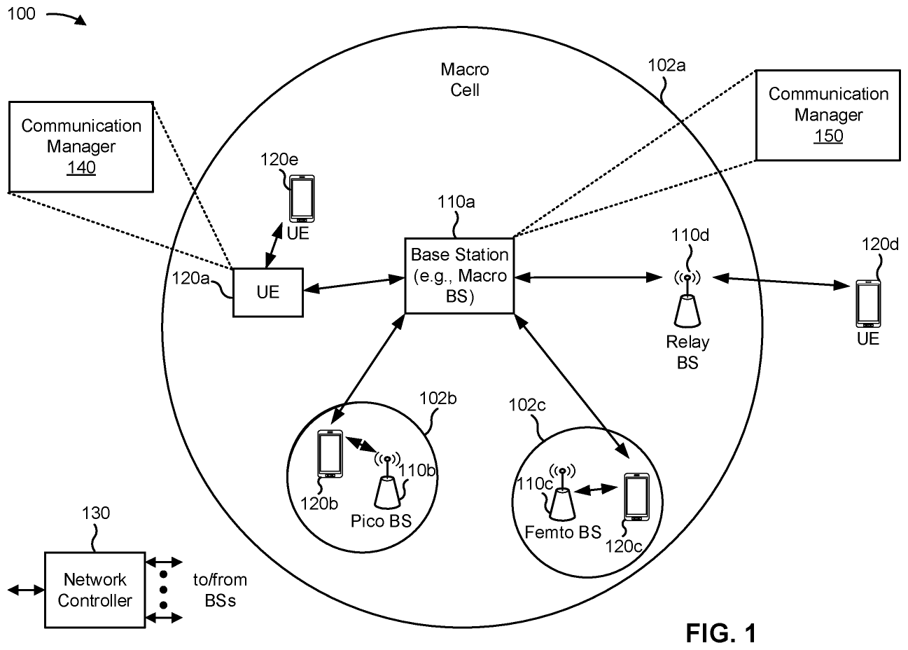

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrow band internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FRI is greater than 6 GHZ, FR1 is often referred to as a “sub-6 GHz” band. Similarly, FR2 is often referred to as a “millimeter wave” band despite being different from the extremely high frequency (EHF) band (30 GHZ-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHZ). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHZ). It is contemplated that the frequencies included in FR1 and FR2 may be modified, and techniques described herein are applicable to those modified frequency ranges.

Radio link monitoring (RLM) is a mechanism for the UE 120 to monitor the quality of a downlink and determine if the radio link is suitable for continued use. RLM may include determining the quality of reference signals, which may be referred to as RLM reference signals. In some aspects, the UE 120 may include a communication manager 140. As described in more detail elsewhere herein, the communication manager 140 may select a set of RLM reference signals according to a rule for selecting the set of RLM reference signals from among RLM reference signals that are quasi-colocated (QCLed) with active transmission control indicator (TCI) states for physical downlink control channel (PDCCH) communications in one or more control resource sets (CORESETs). The one or more CORESETs may include at least one CORESET with at least two active TCI states. The communication manager 140 may monitor for the set of RLM reference signals. Additionally, or alternatively, the communication manager 140 may perform one or more other operations described herein.

In some aspects, the UE 120 may include a communication manager 140. As described in more detail elsewhere herein, the communication manager 140 may select a set of RLM reference signals according to a rule for selecting the set of RLM reference signals from among RLM reference signals that are QCLed with active TCI states for PDCCH communications in CORESETs, where at least one of the PDCCH communications is to be monitored in two linked search space (SS) sets associated with two CORESETs of the CORESETs. The communication manager 140 may monitor for the set of RLM reference signals. Additionally, or alternatively, the communication manager 140 may perform one or more other operations described herein.

In some aspects, the UE 120 may include a communication manager 140. As described in more detail elsewhere herein, the communication manager 140 may select a set of RLM reference signals according to a rule for selecting the set of RLM reference signals from among RLM reference signals that are QCLed with active TCI states for PDCCH communications in CORESETs, where at least two of the RLM reference signals that are QCLed with active TCI states in CORESETs are associated with PDCCH repetition, and where the at least two of the RLM reference signals are associated with SS sets having a same monitoring periodicity. The communication manager 140 may monitor for the set of RLM reference signals. Additionally, or alternatively, the communication manager 140 may perform one or more other operations described herein.

In some aspects, the base station 110 may include a communication manager 150. As described in more detail elsewhere herein, the communication manager 150 may generate an indication of a set of RLM reference signals that a UE is to monitor from among RLM reference signals that are QCLed with active TCI states for PDCCH communications in CORESETs, where at least one of the PDCCH communications is associated with at least two active TCI states. The communication manager 150 may transmit the indication to the UE. Additionally, or alternatively, the communication manager 150 may perform one or more other operations described herein.

As indicated above, FIG. 1 is provided as an example. Other examples may differ from what is described with regard to FIG. 1.

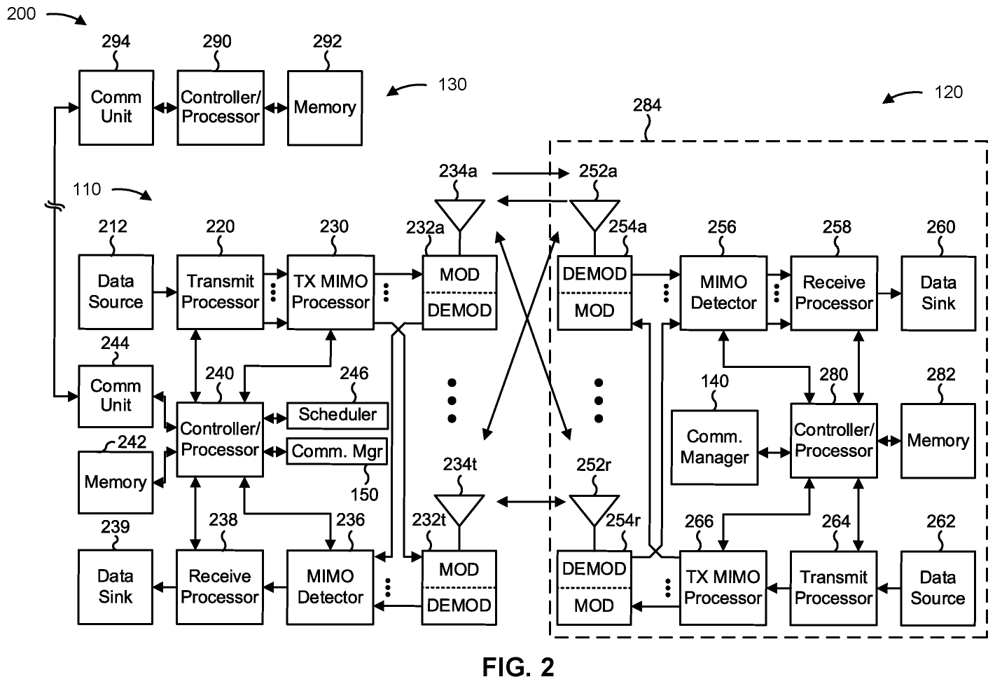

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 1-12).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 1-12).

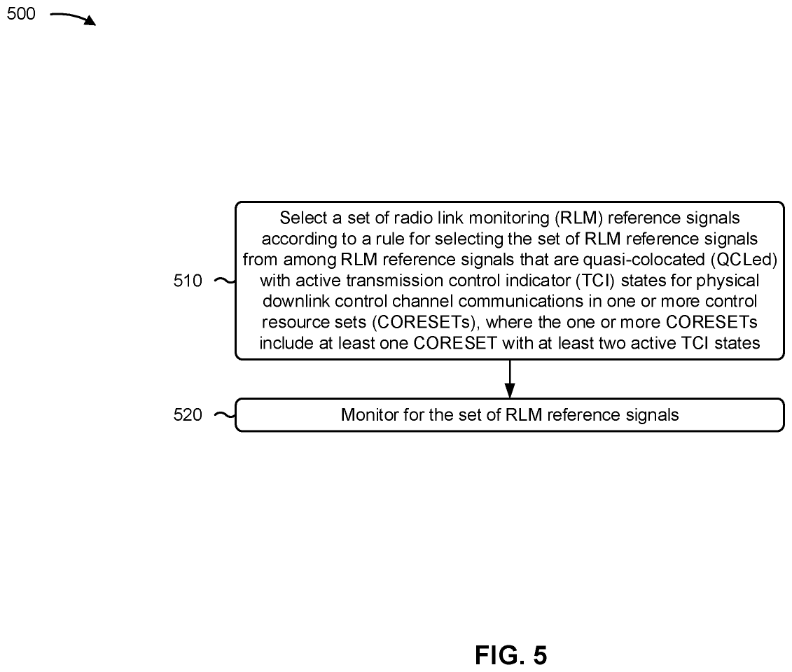

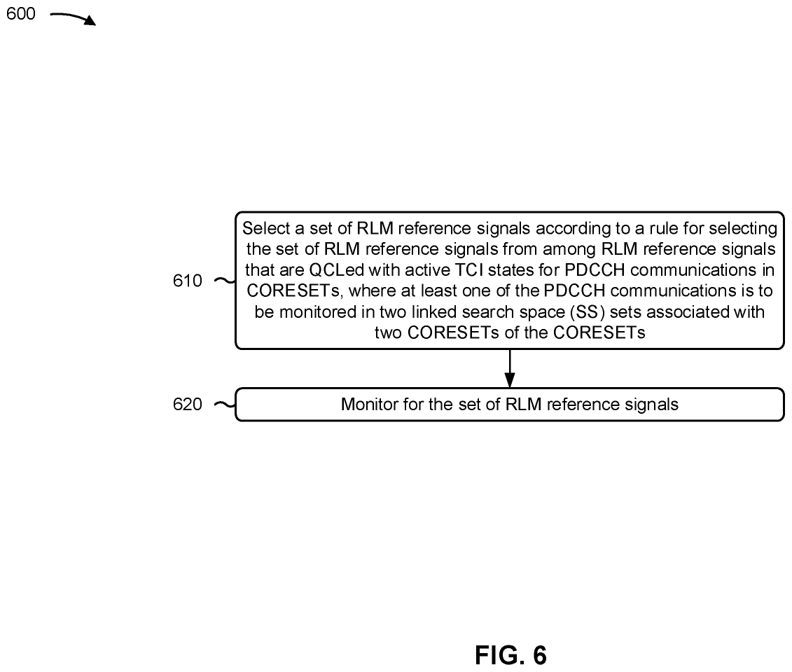

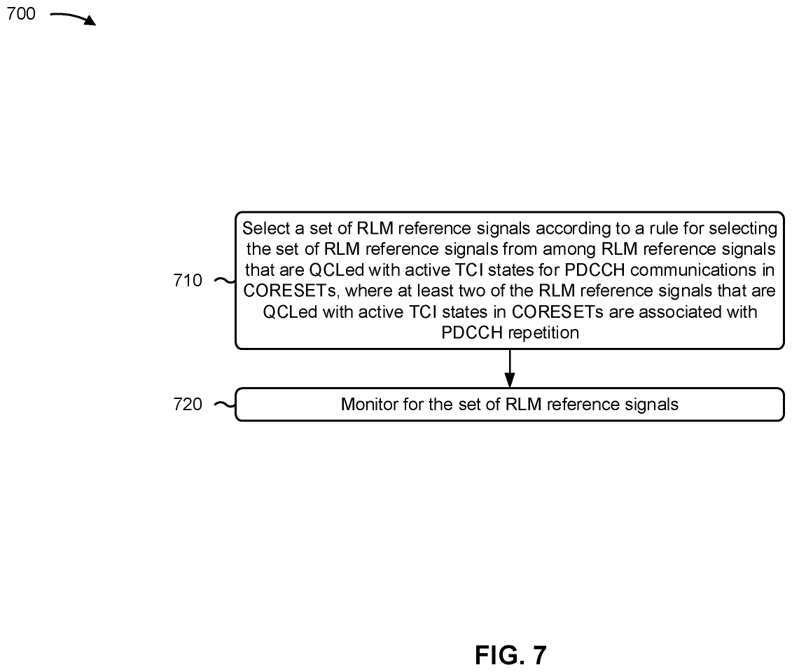

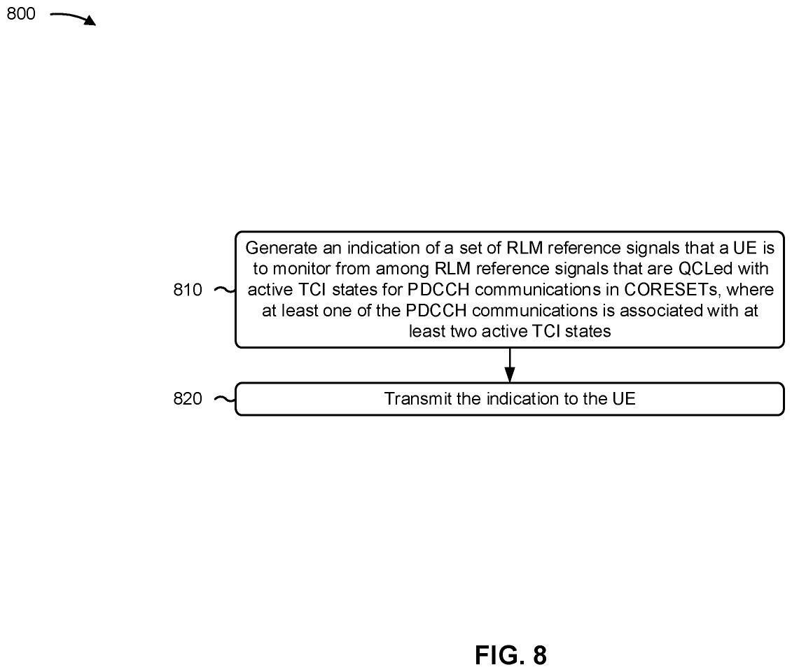

Controller/processor 240 of base station 110, controller/processor 280 of UE 120, and/or any other component(s) of FIG. 2 may perform one or more techniques associated with selecting reference signals for RLM, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, the UE 120 includes means for selecting a set of RLM reference signals according to a rule for selecting the set of RLM reference signals from among RLM reference signals that are QCLed with active TCI states for PDCCH communications in one or more CORESETs, where the one or more CORESETs include at least one CORESET with at least two active TCI states, and/or means for monitoring for the set of RLM reference signals. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for selecting a set of RLM reference signals according to a rule for selecting the set of RLM reference signals from among RLM reference signals that are QCLed with active TCI states for PDCCH communications in CORESETs, where at least one of the PDCCH communications is to be monitored in two linked SS sets associated with two CORESETs of the CORESETs, and/or means for monitoring for the set of RLM reference signals. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for selecting a set of RLM reference signals according to a rule for selecting the set of RLM reference signals from among RLM reference signals that are QCLed with active TCI states for PDCCH communications in CORESETs, where at least two of the RLM reference signals that are QCLed with active TCI states in CORESETs are associated with PDCCH repetition, and where the at least two of the RLM reference signals are associated with SS sets having a same monitoring periodicity, and/or means for monitoring for the set of RLM reference signals. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for generating an indication of a set of RLM reference signals that a UE is to monitor from among RLM reference signals that are QCLed with active TCI states for PDCCH communications in CORESETs, where at least one of the PDCCH communications is associated with at least two active TCI states, and/or means for transmitting the indication to the UE. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

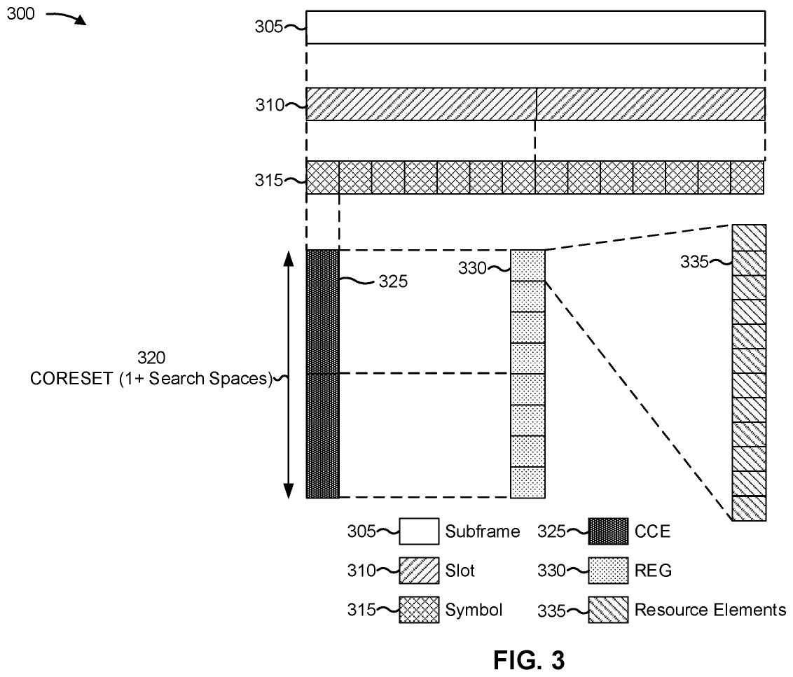

FIG. 3 is a diagram illustrating an example resource structure 300 for wireless communication, in accordance with the present disclosure. Resource structure 300 shows an example of various groups of resources described herein. As shown, resource structure 300 may include a subframe 305. Subframe 305 may include multiple slots 310. While resource structure 300 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 310 may include multiple symbols 315, such as 14 symbols per slot.

The potential control region of a slot 310 may be referred to as a CORESET 320 and may be structured to support an efficient use of resources, such as by flexible configuration or reconfiguration of resources of the CORESET 320 for one or more PDCCHs and/or one or more physical downlink shared channels (PDSCHs). In some aspects, the CORESET 320 may occupy the first symbol 315 of a slot 310, the first two symbols 315 of a slot 310, or the first three symbols 315 of a slot 310. Thus, a CORESET 320 may include multiple resource blocks (RBs) in the frequency domain, and either one, two, or three symbols 315 in the time domain. In 5G, a quantity of resources included in the CORESET 320 may be flexibly configured, such as by using radio resource control (RRC) signaling to indicate a frequency domain region (e.g., a quantity of resource blocks) and/or a time domain region (e.g., a quantity of symbols) for the CORESET 320.

As illustrated, a symbol 315 that includes CORESET 320 may include one or more control channel elements (CCEs) 325, shown as two CCEs 325 as an example, that span a portion of the system bandwidth. A CCE 325 may include downlink control information (DCI) that is used to provide control information for wireless communication. A base station may transmit DCI during multiple CCEs 325 (as shown), where the quantity of CCEs 325 used for transmission of DCI represents the aggregation level (AL) used by the BS for the transmission of DCI. In FIG. 3, an aggregation level of two is shown as an example, corresponding to two CCEs 325 in a slot 310. In some aspects, different aggregation levels may be used, such as 1, 2, 4, 8, 16, or another aggregation level.

Each CCE 325 may include a fixed quantity of resource element groups (REGs) 330, shown as 6 REGs 330, or may include a variable quantity of REGs 330. In some aspects, the quantity of REGs 330 included in a CCE 325 may be specified by a REG bundle size. A REG 330 may include one resource block, which may include 12 resource elements (REs) 335 within a symbol 315. A resource element 335 may occupy one subcarrier in the frequency domain and one OFDM symbol in the time domain.

A search space may include all possible locations (e.g., in time and/or frequency) where a PDCCH may be located. A CORESET 320 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as an SS set.

A CORESET 320 may be interleaved or non-interleaved. An interleaved CORESET 320 may have CCE-to-REG mapping such that adjacent CCEs are mapped to scattered REG bundles in the frequency domain (e.g., adjacent CCEs are not mapped to consecutive REG bundles of the CORESET 320). A non-interleaved CORESET 320 may have a CCE-to-REG mapping such that all CCEs are mapped to consecutive REG bundles (e.g., in the frequency domain) of the CORESET 320.

If there are multiple TRPs that are transmitting the same PDCCH communication (e.g., system information block (SIB), DCI) to a UE in the same time-frequency resources, the UE may be configured to monitor a CORESET that is configured for two TCI states. For example, the PDCCH communication may be repeated in two beams from two TRPs, and the UE may use beam sweeping. Each TCI state may be, for example a QCL-TypeA TCI state that may be associated with an average delay, a delay spread, a Doppler shift, and/or a Doppler spread.

Transmission of the PDCCH communication with two beams may involve several different alternatives. One alternative may include transmission in one CORESET with two TCI states. This may be applicable in a single frequency network (SFN) as a further enhanced MIMO (FeMIMO) enhancement, where a PDCCH communication is transmitted from two TRPs at the same time and frequency. This may improve reliability in high speed train or blockage scenarios. The CORESET may be configured by RRC signaling with a higher layer parameter to indicate that the PDCCH communication received in the CORESET is for an SFN. A medium access control control element (MAC-CE) may also indicate the two TCI states.

Other alternatives for transmission of the PDCCH communication may include the UE being configured to search one SS set associated with two different CORESETs (each CORESET has an active TCI state) or to search two SS sets associated with corresponding CORESETS (each CORESET has an active TCI state). For PDCCH repetition, two SS sets with different CORESETS may be linked by RRC configuration. For intra-slot PDCCH repetition, the two SS sets may have the same periodicity and offset (monitoringSlotPeriodicityAndOffset) and have the same duration.

PDCCH repetition may impact RLM reference signal selection by a UE. The UE may monitor a downlink radio link quality of a primary cell for the purpose of indicating an out-of-synchronization or in-synchronization status to higher layers. If the UE is not provided a reference signal to use for RLM (e.g., by parameter RadioLinkMonitoringRS), the UE may select the reference signal of the active TCI state for PDCCH reception if the active TCI state includes only one reference signal providing QCL information. If the active TCI state includes two reference signals providing QCL information (for example, one providing QCL-TypeA information and the other providing QCL-TypeD information), the UE may expect that one reference signal is configured with QCL-TypeD, and the UE may use this reference signal for RLM. In some aspects, the UE may not expect both reference signals to be configured with QCL-TypeD, and the UE is not expected to use RLM for aperiodic or semi-persistent reference signals. In some other aspects, when the reference signal in the TCI state are aperiodic or semi-persistent reference signals, the UE may determine one periodical reference signal which is QCLed to the reference signal in the TCI state as the RLM reference signal.

If the UE is to use multiple CORESETs for receiving PDCCH communications, such as 5 CORESETs with 5 corresponding TCI states, the UE may have to monitor for 5 candidate RLM reference signals. This may not be acceptable if the UE is configured for monitoring a maximum quantity of reference signals, such as for a maximum number Lₘₐₓ of 4 candidate synchronization signal blocks (SSBs) per half frame. Therefore, the UE may have to down-select to fewer RLM reference signals. Accordingly, the UE may select a lower number N_{RLM} of RLM reference signals to monitor. The UE may select the RLM reference signals according to a rule for selecting RLM reference signals that correspond to active TCI states for PDCCH receptions in CORESETs associated with SS sets. The RLM reference signals may be used for the UE to monitor the radio link quality, beam failure detection, or both.

The UE may select the RLM reference signals in an order starting from a shortest monitoring periodicity for an associated SS set. If multiple CORESETs are associated with the same SS set or with SS sets having the same monitoring periodicity, the UE may determine the order of the CORESETs starting from the highest CORESET index.

The UE may be configured to support PDCCH repetition and monitor a PDCCH with two TCI states, such as for an SFN. In an SFN scenario, the UE may be configured to receive a PDCCH transmission in the same time-frequency resources by two TCI states. Thus, the two TCI states may be associated with an SS set and a CORESET with the same periodicity. In another scenario, PDCCH repetition may be associated with two TRPs, and the UE may be configured to receive the PDCCH repetitions in different time-frequency resources by two TCI states. For example, the two TCI states may be associated with two different SS sets and two CORESETs, but the two different SS sets may have the same periodicity. The UE may select the RLM reference signals associated with the two SS sets that are associated with the PDCCH repetition, since the two SS sets are of the same periodicity. In other words, the UE may not be able to select the proper RLM reference signals when a CORESET is configured with two TCI states.

As indicated above, FIG. 3 is provided as an example. Other examples may differ from what is described with respect to FIG. 3.

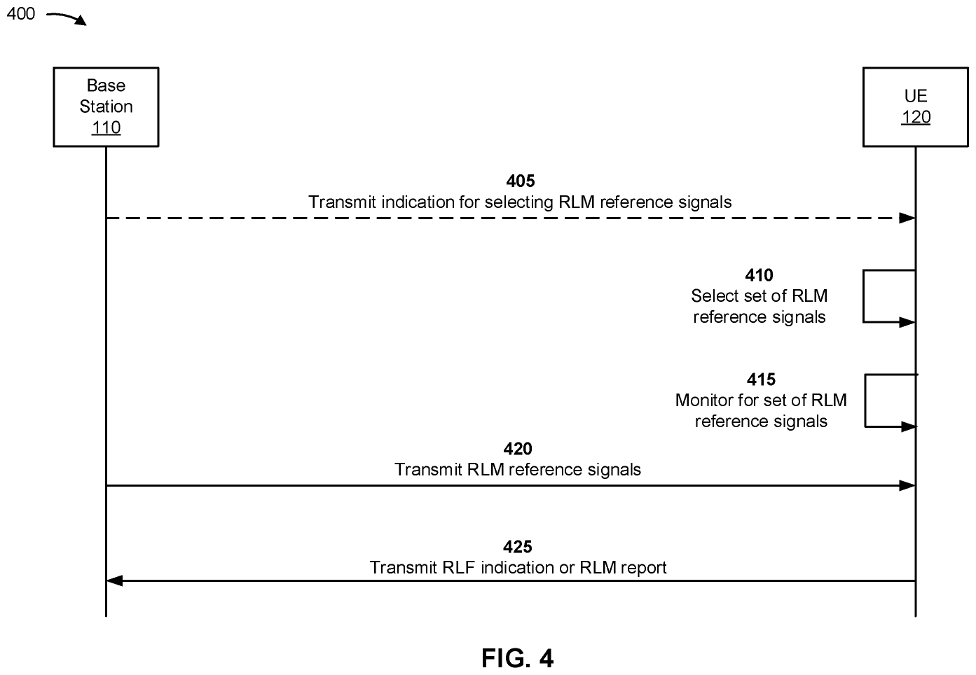

FIG. 4 is a diagram illustrating an example 400 of selecting reference signals for RLM, in accordance with the present disclosure. As shown in FIG. 4, a base station 110 and a UE 120 may communicate with one another.

A UE may select a set of RLM reference signals based at least in part on active TCI states for PDCCH receptions in CORESETSs associated with SS sets in an order from the shortest monitoring periodicity. However, if a CORESET has two TCI states (e.g., multi-TRP scenario) and the associated SS sets have the same periodicity, the UE may lack clarity as to how to select the set of RLM reference signals from among all candidate RLM reference signals. This lack of clarity may cause the UE to monitor more RLM reference signals than necessary and to consume additional processing resources.

According to various aspects described herein, if at least one CORESET has been configured with two TCI states, the UE may select the set of RLM reference signals according to one of multiple ways. Some of these ways may involve QCL reference signals. For example, an RLM reference signal may be transmitted on a beam by a base station according to an active TCI state that the base station uses for PDCCH communications in one or more CORESETs. This beam may be QCLed with a receive beam of the UE that is used for monitoring the RLM reference signal. In other words, the RLM reference signal may be a source reference signal providing QCL type information in the active TCI state, or QCLed with the active TCI state. The UE may select the RLM reference signals when the RLM reference signals are not explicitly indicated to or configured for the UE.

The UE may use a rule for selecting a set of RLM reference signals or may receive an indication of the set of RLM reference signals to use. In some aspects, the UE may select the set of RLM reference signals based at least in part on QCL reference signals of CORESETs with only a single active TCI state. For example, the UE may select the RLM reference signals from the reference signals of the TCI states associated with the CORESETs that are configured with only a single active TCI state. This may involve not selecting RLM reference signals based on the CORESETs with two active TCI states. In some aspects, the UE may select the set of RLM reference signals based at least in part on QCL reference signals of CORESETs with a single TCI state and of CORESETs with two TCI states. For example, the UE may select the RLM reference signals from the reference signals of the TCI states associated with the CORESETs that are configured with a single TCI state or two active TCI states. In some aspects, the UE may select the set of RLM reference signals based at least in part on QCL reference signals of CORESETs with only two TCI states (CORESETs with single TCI state are excluded). For example, the UE may select the RLM reference signals from the reference signals of the TCI states associated with the CORESETs that are configured with two active TCI states. Because the UE may be configured to specifically select RLM reference signals associated with CORESETs with only a single TCI state, CORESETs with two TCI states, or CORESETS with either a single TCI state or two TCI states, depending on the configuration, the UE may have clarity as to which RLM reference signals to select or how to down-select RLM reference signals. As a result, the UE may conserve processing resources by monitoring fewer RLM reference signals and/or monitoring more appropriate RLM reference signals in scenarios where there are multiple TCI states (from multiple TRPs) for a CORESET. While two TCI states are described for example 400, CORESETs may have more than two TCI states and various aspects described herein for CORESETs with two TCI states may be applicable to CORESETs with more than two TCI states.

The set of RLM reference signals may be a proper subset of all candidate RLM reference signals. The candidate RLM reference signals may include RLM reference signals that are QCLed with active TCI states in the CORESETs. A proper subset of RLM reference signals is a set with fewer RLM reference signals than all of the candidate RLM reference signals. In other words, if the set of RLM reference signals is a proper subset, then the candidate RLM reference signals includes the set of RLM reference signals, but the set of RLM reference signals does not include all of the candidate RLM reference signals.

In some aspects, the UE may select the set of RLM reference signals based at least in part on QCL reference signals of CORESETs with a single TCI state or on one QCL reference signal of CORESETs with two TCI states. This may preclude the UE from selecting RLM reference signals that correspond to two QCL reference signals from the same CORESET.

When selecting an RLM reference signal that corresponds to a QCL reference signal for a CORESET with two TCI states, the UE may select, for example, a reference signal that corresponds to a QCL reference signal of a first TCI state or a second TCI state, whichever has a lowest identifier (ID) or a highest ID. The UE may also select an RLM reference signal that corresponds to a QCL reference signal with the smallest reference signal periodicity. The RLM reference signal selections may apply for higher numbers of reference signals, including, for example, when Lₘₐₓ=8.

In some aspects, the UE 120 may assess a radio link quality instance of a reference signal against an incoming quality threshold Qin or an outgoing quality threshold Qₒᵤₜ. For example, the UE 120 may assess a radio link quality of different reference signals, including channel state information reference signals (CSI-RSs) or SSBs, and select a QCL reference signal, a CSI-RS, or an SSB to use as an RLM reference signal based at least in part on a result of comparing radio link qualities.

In some aspects, the UE 120 may calculate an average radio link quality based at least in part on reference signal pairs where averaging can be a weighted averaging of radio link qualities of each reference signal. An average functionality may be a weighted power mean:

$${( {w}_{1} R L {M}_{1}^{p} + {w}_{2} R L {M}_{2}^{p} )}^{\frac{1}{p}}$$

where w₁+w₂=1 and p={−∞, . . . , −1, 0, 1 . . . ∞}. If p=−∞, then the mean may be a minimum of RLM₁ and RML₂. RML₁ may represent the radio link quality of a first RLM reference signal in the reference signal pair and RML₂ may represent the radio link quality of a second RLM reference signal in the reference signal pair. If p=−1, then the mean may be a harmonic mean of RML₁ and RML₂. If p=0, then the mean may be a geometric mean, or the square root of (RLM₁^{w}^{₁}×RLM₂^{w}^{₂}). If p=1, then the mean may be an arithmetic mean, or (RML₁+RML₂)/2. If p=∞, then the mean may be a maximum of RML₁ and RML₂.

Example 400 shows RLM reference signal selection, and example 400 may involve an SFN. As shown by reference number 405, in some aspects, the base station 110 may optionally generate and transmit an indication of a set of RLM reference signals that the UE 120 is to monitor from among RLM reference signals that are QCLed with active TCI states for PDCCH communications in CORESETs, where at least one of the PDCCH communications is associated with at least two active TCI states. The base station 110 may transmit the indication in an RRC message or a MAC-CE. Alternatively, or additionally, in some aspects, the UE 120 may be configured by RRC signaling or stored configuration information (according to a standard) to select RLM reference signals for specified CORESETs.

In some aspects, at least one of the RLM reference signals in an indicated set of RLM reference signals may be part of a pair of CSI-RSs or a pair of SSBs. The indicated set may be transmitted to the UE 120 by RRC signaling or by a MAC-CE. That is, a pair of CSI-RS resources or SSBs may be indicated, and one of the RLM reference signals may be one of the paired CSI-RSs or one of the paired SSBs. For example, the RLM reference signals may be a pair of CSI-RSs, or the RLM reference signals may be a pair of SSBs. If reference signal pairing is not allowed, other indications may be used for selecting RLM reference signals. That is, none of the set of RLM reference signals may be part of a CSI-RS pair or an SSB pair.

As shown by reference number 410, the UE 120 may select the set of RLM reference signals according to a rule. For example, the rule may specify selection of: 1) only RLM reference signals associated with CORESETs with a single active TCI state: 2) only RLM reference signals associated with CORESETs with two active TCI states: 3) RLM reference signals associated with either CORESETs with a single active TCI state or CORESETs with two active TCI states, or either a RLM reference signal associated with CORESETs with a single TCI state or only one RLM reference signal associated with CORESETs with two active TCI states.

In some aspects, if an RLM reference signal is to be selected from among multiple RLM reference signals with equal properties, the UE 120 may select the RLM reference signals based at least in part on a TCI state ID (e.g., highest, lowest) and/or a reference signal periodicity (e.g., smallest periodicity).

In some aspects, the UE 120 may select RLM reference signals associated with a specified CORESET pool index if CORESETs are of different CORESET pool indices (multi-TRP scenario). For example, the specified CORESET pool index may be a predetermined CORESET pool index, where the predetermined CORESET is indicated in RRC signaling or in stored configuration information. In some aspects, the specified CORESET pool index may include any CORESET pool index (any TRP). In such a case, RLM reference signals may be associated with SS sets and selection may be based at least in part on a shortest monitoring periodicity. However, if a monitoring periodicity of SS sets associated with multiple RLM reference signals is the same, the UE 120 may select RLM reference signals based at least in part on an associated CORESET pool ID, an associated CORESET ID, or an associated search space set ID. For example, the UE 120 may select RLM reference signals associated with a lowest CORESET pool ID or a highest CORESET pool ID. The UE 120 may select RLM reference signals associated with a lowest CORESET ID or a highest CORESET ID. The UE 120 may select RLM reference signals with a lowest SS set ID or a highest SS set ID.

As shown by reference number 415, the UE 120 may monitor for the set of RLM reference signals. This may include adjusting or reducing a beam configuration or multiple spatial relations according to TCI states of CORESETs that are associated with the set of RLM reference signals.

As shown by reference number 420, the base station 110 may transmit RLM reference signals, including the set of RLM reference signals. The base station 110 may be aware of the set of RLM reference signals for which the UE 120 is to monitor according to the configuration that the UE 120 uses for selecting the set of RLM reference signals. The base station 110 may have also transmitted an explicit indication for which of the set of RLM reference signals to monitor, as shown by reference number 405.

If the UE 120 detects a radio link failure (RLF) when monitoring RLM reference signals, the UE 120 may transmit an indication of RLF or some type of RLM report, as shown by reference number 425.

In some aspects, example 400 may involve PDCCH repetition in a non-SFN. PDCCH repetition may include transmission of the same PDCCH communication (e.g., transport block) in multiple repetition occasions. PDCCH repetition may increase a chance of successful PDCCH transmission success and this may impact selection of an RLM reference signal, because RLM may not be necessary or accurate for instances of PDCCH repetition. The UE 120 may monitor at least one PDCCH in two linked SS sets associated with two CORESETS. The UE 120 may select the set of RLM reference signals based at least in part on QCL reference signals of CORESETs that are not associated with any PDCCH repetition. In some aspects, the UE 120 may select the set of RLM reference signals based at least in part on QCL reference signals of CORESETs that are associated with any PDCCH repetition. In some aspects, the UE 120 may select the set of RLM reference signals based at least in part on QCL reference signals of all of the CORESETs with active TCI states.

In some aspects, the UE 120 may preclude selecting RLM reference signals corresponding to two QCL reference signals from CORESETs associated with PDCCH repetition. For example, the UE 120 may select RLM reference signals corresponding to QCL reference signals of CORESETs that are associated with any PDCCH repetition or select RLM reference signals corresponding to one QCL reference signal of the CORESETs associated with PDCCH repetition.

In some aspects, if the UE 120 is to select an RLM reference signal corresponding to one QCL reference signal from two CORESETs of the same monitoring SS set periodicity associated with PDCCH repetition, the UE 120 may select an RLM reference signal that corresponds to a QCL reference signal with a lowest CORESET ID, a highest CORESET ID, a lowest SS set ID, a highest SS set ID, a lowest TCI ID, a highest TCI ID, or the QCL reference signal with the smallest reference signal periodicity.

In some aspects, the UE 120 may prioritize selection of RLM reference signals when ordering according to a monitoring periodicity. In this case, the UE 102 may expect that two reference signals associated with a PDCCH repetition have the same monitoring periodicity. The UE 120 may prioritize, for selection, RLM reference signals associated with SS sets in decreasing order of monitoring periodicity. For example, an RLM reference signal associated with an SS set with a largest effective monitoring periodicity (e.g., double the SS set periodicity) may have priority over RLM reference signals associated with an SS set with a smaller effective monitoring periodicity. Alternatively, an RLM reference signal associated with an SS set with a smallest effective monitoring periodicity (e.g., half the SS set periodicity) may have priority over RLM reference signals associated with an SS set with a larger effective monitoring periodicity.

In some aspects, the UE 120 may prioritize selection according to a scaled effective periodicity that is based on a configuration. For example, the base station 110 may indicate, via RRC signaling, a value by which to scale the monitoring SS set periodicity. This may include multiplying a periodicity associated with specified RLM reference signals by the value (e.g., less than 1, greater than 1) in order to prioritize RLM reference signal selection according to a configuration.

By using a configuration for RLM reference signal selection, the UE 120 may have clarity in selecting RLM reference signals and/or down-selecting RLM reference signals for which the UE 120 is to monitor. This may cause the UE 120 to conserve processing resources.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with selecting reference signals for RLM.

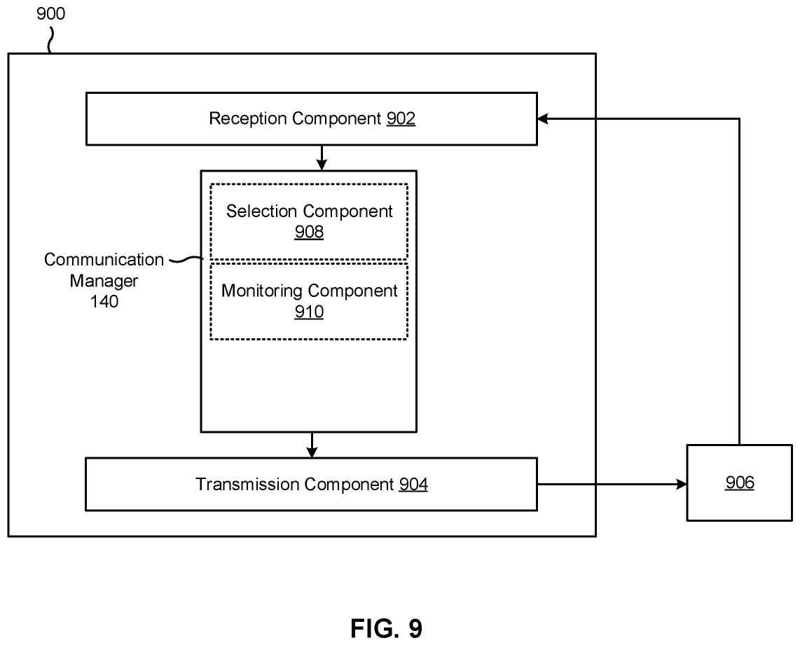

As shown in FIG. 5, in some aspects, process 500 may include selecting a set of RLM reference signals according to a rule for selecting the set of RLM reference signals from among RLM reference signals that are QCLed with active TCI states for PDCCH communications in one or more CORESETs (block 510). For example, the UE (e.g., using communication manager 140 and/or selection component 908 depicted in FIG. 9) may select a set of RLM reference signals according to a rule for selecting the set of RLM reference signals from among RLM reference signals that are QCLed with active TCI states for PDCCH communications in one or more CORESETs, as described above. In some aspects, the one or more CORESETs include at least one CORESET with at least two active TCI states.

As further shown in FIG. 5, in some aspects, process 500 may include monitoring for the set of RLM reference signals (block 520). For example, the UE (e.g., using communication manager 140 and/or monitoring component 910 depicted in FIG. 9) may monitor for the set of RLM reference signals, as described above.

Process 500 may include additional aspects, such as any single aspect or any combination of aspects described below and/or in connection with one or more other processes described elsewhere herein.

In a first aspect, the set of RLM reference signals is a proper subset of the RLM reference signals that are QCLed with active TCI states in the one or more CORESETs.

In a second aspect, alone or in combination with the first aspect, the one or more CORESETs are used in an SFN, and the rule specifies that only RLM reference signals associated with CORESETs with only a single TCI state are selected.

In a third aspect, alone or in combination with one or more of the first and second aspects, the one or more CORESETs are used in an SFN, and the rule specifies that RLM reference signals associated with CORESETs with only a single TCI state and CORESETs with at least two active TCI states are selected.

In a fourth aspect, alone or in combination with one or more of the first through third aspects, the one or more CORESETs are used in an SFN, and the rule specifies that only RLM reference signals associated with CORESETs with two TCI states are selected.

In a fifth aspect, alone or in combination with one or more of the first through fourth aspects, the one or more CORESETs are used in an SFN, and the rule specifies that either RLM reference signals associated with CORESETs with only a single TCI state or one RLM reference signal associated with CORESETs with two TCI states are selected.

In a sixth aspect, alone or in combination with one or more of the first through fifth aspects, one RLM reference signal associated with CORESETs with two TCI states is selected based at least in part on a TCI state identifier or a reference signal periodicity.

In a seventh aspect, alone or in combination with one or more of the first through sixth aspects, the UE is configured with CORESETs of different CORESET pool indices, and selecting the set of RLM reference signals includes selecting RLM reference signals associated with a specified CORESET pool index.

In an eighth aspect, alone or in combination with one or more of the first through seventh aspects, the UE is configured with CORESETs of different CORESET pool indices, and selecting the set of RLM reference signals includes selecting RLM reference signals based at least in part on an associated CORESET ID, an associated CORESET ID, or an associated search space set ID.

In a ninth aspect, alone or in combination with one or more of the first through eighth aspects, selecting the set of RLM reference signals includes selecting the set of RLM reference signals based at least in part on radio link quality.

In a tenth aspect, alone or in combination with one or more of the first through ninth aspects, a radio link quality for an RLM reference signal is assessed based at least in part on a pairing of the RLM reference signal with another reference signal.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a UE, in accordance with the present disclosure. Example process 600 is an example where the UE (e.g., UE 120) performs operations associated with selecting reference signals for RLM.

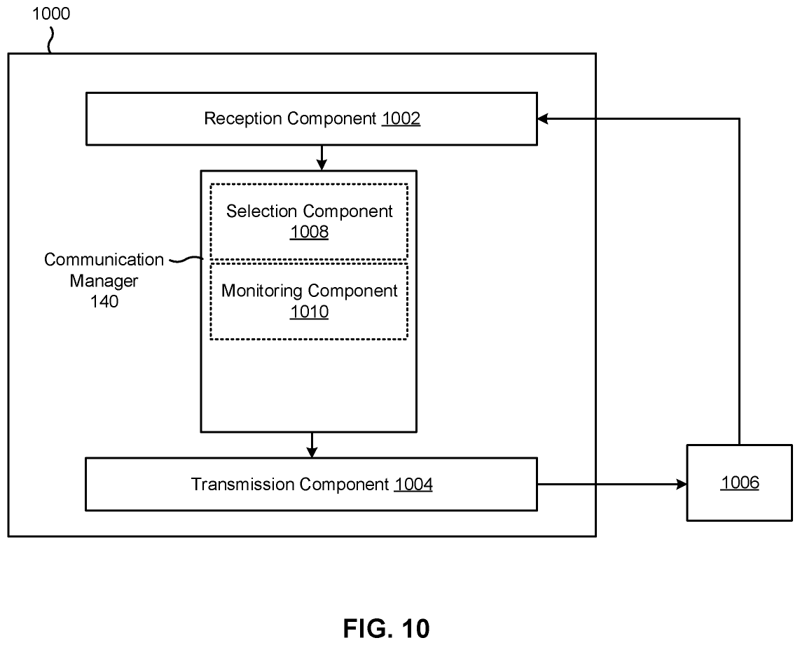

As shown in FIG. 6, in some aspects, process 600 may include selecting a set of RLM reference signals according to a rule for selecting the set of RLM reference signals from among RLM reference signals that are QCLed with active TCI states for PDCCH communications in CORESETs (block 610). For example, the UE (e.g., using communication manager 140 and/or selection component 1008 depicted in FIG. 10) may select a set of RLM reference signals according to a rule for selecting the set of RLM reference signals from among RLM reference signals that are QCLed with active TCI states for PDCCH communications in CORESETs, as described above. In some aspects, at least one of the PDCCH communications is to be monitored in two linked SS sets associated with two CORESETs of the CORESETs. The SS sets may be linked SS sets by being associated with each other for PDCCH communications or CORESETs used by the UE.

As further shown in FIG. 6, in some aspects, process 600 may include monitoring for the set of RLM reference signals (block 620). For example, the UE (e.g., using communication manager 140 and/or monitoring component 1010 depicted in FIG. 10) may monitor for the set of RLM reference signals, as described above.

Process 600 may include additional aspects, such as any single aspect or any combination of aspects described below and/or in connection with one or more other processes described elsewhere herein.

In a first aspect, the set of RLM reference signals is a proper subset of the RLM reference signals that are QCLed with active TCI states in the CORESETs.

In a second aspect, alone or in combination with the first aspect, the CORESETs are used in a non-single frequency network, and the rule specifies selection from among RLM reference signals associated with CORESETs that are not associated with PDCCH repetition.

In a third aspect, alone or in combination with one or more of the first and second aspects, the CORESETs are used in a non-SFN, and the rule specifies selection from among RLM reference signals associated with CORESETs that are associated with PDCCH repetition.

In a fourth aspect, alone or in combination with one or more of the first through third aspects, the one or more CORESETs are used in a non-SFN, and the rule specifies selection from among RLM reference signals associated with all of the CORESETs.

In a fifth aspect, alone or in combination with one or more of the first through fourth aspects, the one or more CORESETs are used in a non-SFN, and the rule specifies selecting either RLM reference signals not associated with PDCCH repetition or one RLM reference signal associated with CORESETs associated with PDCCH repetition.

In a sixth aspect, alone or in combination with one or more of the first through fifth aspects, one RLM reference signal associated with CORESETs associated with PDCCH repetition is selected based at least in part on a TCI state identifier or a reference signal periodicity.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with selecting reference signals for RLM.

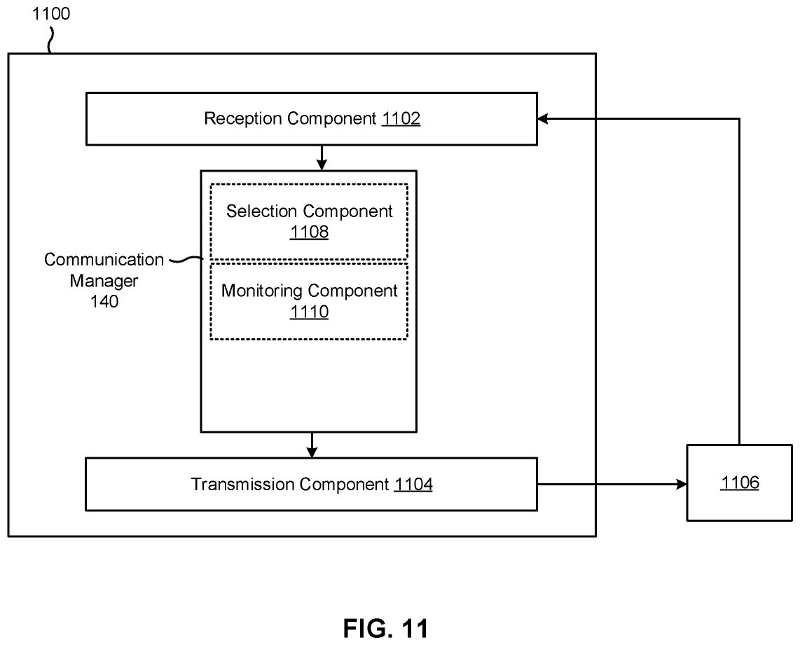

As shown in FIG. 7, in some aspects, process 700 may include selecting a set of RLM reference signals according to a rule for selecting the set of RLM reference signals from among RLM reference signals that are QCLed with active TCI states for PDCCH communications in CORESETs, (block 710). For example, the UE (e.g., using communication manager 140 and/or selection component 1108 depicted in FIG. 11) may select a set of RLM reference signals according to a rule for selecting the set of RLM reference signals from among RLM reference signals that are QCLed with active TCI states for PDCCH communications in CORESETs, as described above. In some aspects, at least two of the RLM reference signals that are QCLed with active TCI states in CORESETs are associated with PDCCH repetition, and the at least two of the RLM reference signals are associated with SS sets having a same monitoring periodicity.

As further shown in FIG. 7, in some aspects, process 700 may include monitoring for the set of RLM reference signals (block 720). For example, the UE (e.g., using communication manager 140 and/or monitoring component 1110 depicted in FIG. 11) may monitor for the set of RLM reference signals, as described above.

Process 700 may include additional aspects, such as any single aspect or any combination of aspects described below and/or in connection with one or more other processes described elsewhere herein.

In a first aspect, the set of RLM reference signals is a proper subset of the RLM reference signals that are QCLed with active TCI states in the CORESETs.

In a second aspect, alone or in combination with the first aspect, process 700 includes prioritizing, for selection, RLM reference signals associated with SS sets in decreasing order of monitoring periodicity.

In a third aspect, alone or in combination with one or more of the first and second aspects, process 700 includes prioritizing, for selection, RLM reference signals associated with SS sets in increasing order of monitoring periodicity.

In a fourth aspect, alone or in combination with one or more of the first through third aspects, process 700 includes prioritizing, for selection, RLM reference signals associated with SS sets in an order according to a scaled effective periodicity.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with selecting reference signals for RLM.

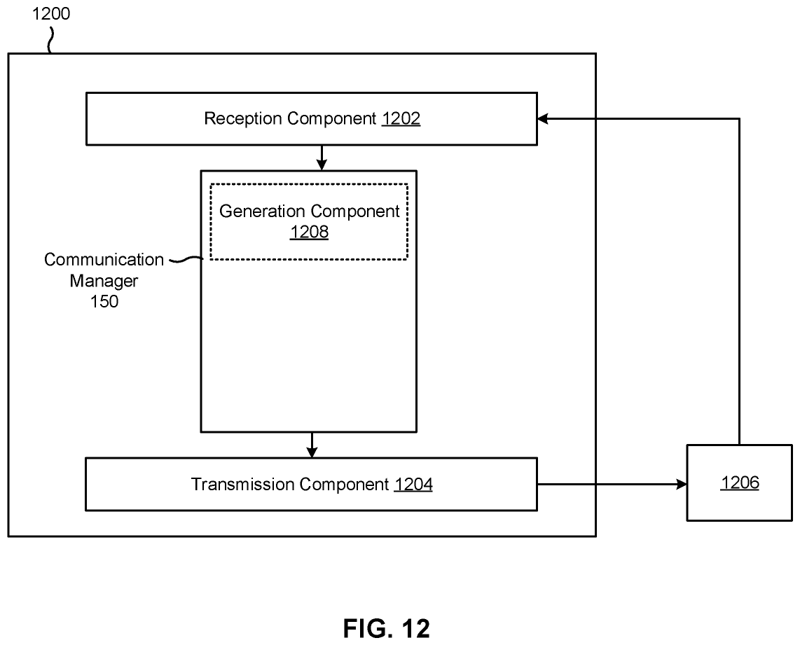

As shown in FIG. 8, in some aspects, process 800 may include generating an indication of a set of RLM reference signals that a UE is to monitor from among RLM reference signals that are QCLed with active TCI states for PDCCH communications in CORESETs (block 810). For example, the base station (e.g., using communication manager 150 and/or generation component 1208 depicted in FIG. 12) may generate an indication of a set of RLM reference signals that a UE is to monitor from among RLM reference signals that are QCLed with active TCI states for PDCCH communications in CORESETs, as described above. In some aspects, at least one of the PDCCH communications is associated with at least two active TCI states.

As further shown in FIG. 8, in some aspects, process 800 may include transmitting the indication to the UE (block 820). For example, the base station (e.g., using communication manager 150 and/or transmission component 1204 depicted in FIG. 12) may transmit the indication to the UE, as described above.

Process 800 may include additional aspects, such as any single aspect or any combination of aspects described below and/or in connection with one or more other processes described elsewhere herein.

In a first aspect, the indication is transmitted in an RRC message or a MAC-CE, and at least one of the RLM reference signals in the set of RLM reference signals is part of a pair of CSI-RSs or a pair of SSBs.

In a second aspect, alone or in combination with the first aspect, the indication is transmitted in an RRC message or a MAC-CE, and none of the set of RLM reference signals is part of a pair of CSI-RSs or a pair of SSBs.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE (e.g., UE 120), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, a TRP, or another wireless communication device) using the reception component 902 and the transmission component 904. As further shown, the apparatus 900 may include the communication manager 140. The communication manager 140 may include a selection component 908 and/or a monitoring component 910, among other examples.

In some aspects, the apparatus 900 may be configured to perform one or more operations described herein in connection with FIGS. 1-4. Additionally, or alternatively, the apparatus 900 may be configured to perform one or more processes described herein, such as process 500 of FIG. 5. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The selection component 908 may select a set of RLM reference signals according to a rule for selecting the set of RLM reference signals from among RLM reference signals that are QCLed with active TCI states for PDCCH communications in one or more CORESETs, where the one or more CORESETs include at least one CORESET with at least two active TCI states. The monitoring component 910 may monitor for the set of RLM reference signals.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a UE (e.g., UE 120), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, a TRP, or another wireless communication device) using the reception component 1002 and the transmission component 1004. As further shown, the apparatus 1000 may include the communication manager 140. The communication manager 140 may include a selection component 1008 and/or a monitoring component 1010, among other examples.

In some aspects, the apparatus 1000 may be configured to perform one or more operations described herein in connection with FIGS. 1-4. Additionally, or alternatively, the apparatus 1000 may be configured to perform one or more processes described herein, such as process 600 of FIG. 6. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The selection component 1008 may select a set of RLM reference signals according to a rule for selecting the set of RLM reference signals from among RLM reference signals that are QCLed with active TCI states for PDCCH communications in CORESETs, where at least one of the PDCCH communications is to be monitored in two linked search space (SS) sets associated with two CORESETs of the CORESETs. The monitoring component 1010 may monitor for the set of RLM reference signals.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a UE (e.g., UE 120), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, a TRP, or another wireless communication device) using the reception component 1102 and the transmission component 1104. As further shown, the apparatus 1100 may include the communication manager 140. The communication manager 140 may include a selection component 1108 and/or a monitoring component 1110, among other examples.

In some aspects, the apparatus 1100 may be configured to perform one or more operations described herein in connection with FIGS. 1-4. Additionally, or alternatively, the apparatus 1100 may be configured to perform one or more processes described herein, such as process 700 of FIG. 7. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The selection component 1108 may select a set of RLM reference signals according to a rule for selecting the set of RLM reference signals from among RLM reference signals that are QCLed with active TCI states for PDCCH communications in CORESETs, where at least two of the RLM reference signals that are QCLed with active TCI states in CORESETs are associated with PDCCH repetition, and where the at least two of the RLM reference signals are associated with SS sets having a same monitoring periodicity. The monitoring component 1110 may monitor for the set of RLM reference signals.

The selection component 1108 may prioritize, for selection, RLM reference signals associated with SS sets in decreasing order of monitoring periodicity. The selection component 1108 may prioritize, for selection, RLM reference signals associated with SS sets in increasing order of monitoring periodicity. The selection component 1108 may prioritize, for selection, RLM reference signals associated with SS sets in an order according to a scaled effective periodicity.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be a base station (e.g., base station 110) or a TRP associated with the base station, or a base station or a TRP may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a generation component 1208, among other examples.

In some aspects, the apparatus 1200 may be configured to perform one or more operations described herein in connection with FIGS. 1-4. Additionally, or alternatively, the apparatus 1200 may be configured to perform one or more processes described herein, such as process 800 of FIG. 8. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The generation component 1208 may generate an indication of a set of RLM reference signals that a UE is to monitor from among RLM reference signals that are QCLed with active TCI states for PDCCH communications in CORESETs, where at least one of the PDCCH communications is associated with at least two active TCI states. The transmission component 1204 may transmit the indication to the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: selecting a set of radio link monitoring (RLM) reference signals according to a rule for selecting the set of RLM reference signals from among RLM reference signals that are quasi-colocated (QCLed) with active transmission control indicator (TCI) states for physical downlink control channel communications in one or more CORESETs, wherein the one or more CORESETs include at least one CORESET with at least two active TCI states: and monitoring for the set of RLM reference signals.
Aspect 2: The method of Aspect 1, wherein the set of RLM reference signals is a proper subset of the RLM reference signals that are QCLed with active TCI states in the one or more CORESETs.
Aspect 3: The method of Aspect 1 or 2, wherein the one or more CORESETs are used in a single frequency network, and wherein the rule specifies that only RLM reference signals associated with CORESETs with only a single TCI state are selected.
Aspect 4: The method of Aspect 1 or 2, wherein the one or more CORESETs are used in a single frequency network, and wherein the rule specifies that RLM reference signals associated with CORESETs with only a single TCI state and CORESETs with at least two active TCI states are selected.
Aspect 5: The method of Aspect 1 or 2, wherein the one or more CORESETs are used in a single frequency network, and wherein the rule specifies that only RLM reference signals associated with CORESETs with two TCI states are selected.
Aspect 6: The method of Aspect 1 or 2, wherein the one or more CORESETs are used in a single frequency network, and wherein the rule specifies that either RLM reference signals associated with CORESETs with only a single TCI state or one RLM reference signal associated with CORESETs with two TCI states are selected.
Aspect 7: The method of Aspect 6, wherein one RLM reference signal associated with CORESETs with two TCI states is selected based at least in part on a TCI state identifier or a reference signal periodicity.
Aspect 8: The method of any of Aspects 1-7, wherein the UE is configured with CORESETs of different CORESET pool indices, and wherein selecting the set of RLM reference signals includes selecting RLM reference signals associated with a specified CORESET pool index.
Aspect 9: The method of any of Aspects 1-8, wherein the UE is configured with CORESETs of different CORESET pool indices, and wherein selecting the set of RLM reference signals includes selecting RLM reference signals based at least in part on an associated CORESET pool identifier (ID), an associated CORESET ID, or an associated search space set ID.
Aspect 10: The method of any of Aspects 1-10, wherein selecting the set of RLM reference signals includes selecting the set of RLM reference signals based at least in part on radio link quality.
Aspect 11: The method of Aspect 10, wherein a radio link quality for an RLM reference signal is assessed based at least in part on a pairing of the RLM reference signal with another reference signal.
Aspect 12: A method of wireless communication performed by a user equipment (UE), comprising: selecting a set of radio link monitoring (RLM) reference signals according to a rule for selecting the set of RLM reference signals from among RLM reference signals that are quasi-colocated (QCLed) with active transmission control indicator (TCI) states for physical downlink control channel (PDCCH) communications in control resource sets (CORESETs), wherein at least one of the PDCCH communications is to be monitored in two linked search space (SS) sets associated with two CORESETs of the CORESETs; and monitoring for the set of RLM reference signals.
Aspect 13: The method of Aspect 12, wherein the set of RLM reference signals is a proper subset of the RLM reference signals that are QCLed with active TCI states in the CORESETs.
Aspect 14: The method of Aspect 12 or 13, wherein the CORESETs are used in a non-single frequency network, and wherein the rule specifies selection from among RLM reference signals associated with CORESETs that are not associated with PDCCH repetition.
Aspect 15: The method of Aspect 12 or 13, wherein the CORESETs are used in a non-single frequency network, and wherein the rule specifies selection from among RLM reference signals associated with CORESETs that are associated with PDCCH repetition.
Aspect 16: The method of Aspect 12 or 13, wherein the one or more CORESETs are used in a non-single frequency network, and wherein the rule specifies selection from among RLM reference signals associated with all of the CORESETs.
Aspect 17: The method of Aspect 12 or 13, wherein the one or more CORESETs are used in a non-single frequency network, and wherein the rule specifies selecting either RLM reference signals not associated with PDCCH repetition or one RLM reference signal associated with CORESETs associated with PDCCH repetition.
Aspect 18: The method of Aspect 17, wherein one RLM reference signal associated with CORESETs associated with PDCCH repetition is selected based at least in part on a TCI state identifier or a reference signal periodicity.
Aspect 19: A method of wireless communication performed by a user equipment (UE), comprising: selecting a set of radio link monitoring (RLM) reference signals according to a rule for selecting the set of RLM reference signals from among RLM reference signals that are quasi-colocated (QCLed) with active transmission control indicator (TCI) states for physical downlink control channel (PDCCH) communications in control resource sets (CORESETs), wherein at least two of the RLM reference signals that are QCLed with active TCI states in CORESETs are associated with PDCCH repetition, and wherein the at least two of the RLM reference signals are associated with search space (SS) sets having a same monitoring periodicity: and monitoring for the set of RLM reference signals.
Aspect 20: The method of Aspect 19, wherein the set of RLM reference signals is a proper subset of the RLM reference signals that are QCLed with active TCI states in the CORESETs.
Aspect 21: The method of Aspect 19 or 20, further comprising prioritizing, for selection, RLM reference signals associated with SS sets in decreasing order of monitoring periodicity.
Aspect 22: The method of Aspect 19 or 20, further comprising prioritizing, for selection, RLM reference signals associated with SS sets in increasing order of monitoring periodicity.
Aspect 23: The method of Aspect 19 or 20, further comprising prioritizing, for selection, RLM reference signals associated with SS sets in an order according to a scaled effective periodicity.
Aspect 24: A method of wireless communication performed by a base station, comprising: generating an indication of a set of radio link monitoring (RLM) reference signals that a user equipment (UE) is to monitor from among RLM reference signals that are quasi-colocated (QCLed) with active transmission control indicator (TCI) states for physical downlink control channel (PDCCH) communications in control resource sets (CORESETs), wherein at least one of the PDCCH communications is associated with at least two active TCI states: and transmitting the indication to the UE.
Aspect 25: The method of Aspect 24, wherein the indication is transmitted in a radio resource control message or a medium access control control element (MAC-CE), and wherein at least one of the RLM reference signals in the set of RLM reference signals is part of a pair of channel state information reference signals or a pair of synchronization signal blocks.
Aspect 26: The method of Aspect 24, wherein the indication is transmitted in a radio resource control message or a medium access control control element (MAC-CE), and wherein none of the set of RLM reference signals is part of a pair of channel state information reference signals or a pair of synchronization signal blocks.
Aspect 27: An apparatus for wireless communication at a device, comprising a processor: memory coupled with the processor: and instructions stored in the memory and executable by the processor to cause the apparatus to perform the method of one or more of Aspects 1-26.
Aspect 28: A device for wireless communication, comprising a memory and one or more processors coupled to the memory, the one or more processors configured to perform the method of one or more of Aspects 1-26.
Aspect 29: An apparatus for wireless communication, comprising at least one means for performing the method of one or more of Aspects 1-26.
Aspect 30: A non-transitory computer-readable medium storing code for wireless communication, the code comprising instructions executable by a processor to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
select a set of radio link monitoring (RLM) reference signals according to a rule for selecting the set of RLM reference signals from among RLM reference signals that are quasi-colocated (QCLed) with active transmission control indicator (TCI) states for physical downlink control channel communications in one or more control resource sets (CORESETs), wherein the one or more CORESETs include at least one CORESET with at least two active TCI states; and
monitor for the set of RLM reference signals.

2. The UE of claim 1, wherein the set of RLM reference signals is a proper subset of the RLM reference signals that are QCLed with active TCI states in the one or more CORESETs.

3. The UE of claim 1, wherein the one or more CORESETs are used in a single frequency network, and wherein the rule specifies that only RLM reference signals associated with CORESETs with only a single TCI state are selected.

4. The UE of claim 1, wherein the one or more CORESETs are used in a single frequency network, and wherein the rule specifies that RLM reference signals associated with CORESETs with only a single TCI state and CORESETs with at least two active TCI states are selected.

5. The UE of claim 1, wherein the one or more CORESETs are used in a single frequency network, and wherein the rule specifies that only RLM reference signals associated with CORESETs with two TCI states are selected.

6. The UE of claim 1, wherein the one or more CORESETs are used in a single frequency network, and wherein the rule specifies that either RLM reference signals associated with CORESETs with only a single TCI state or one RLM reference signal associated with CORESETs with two TCI states are selected.

7. The UE of claim 6, wherein one RLM reference signal associated with CORESETs with two TCI states is selected based at least in part on a TCI state identifier or a reference signal periodicity.

8. The UE of claim 1, wherein the UE is configured with CORESETs of different CORESET pool indices, and wherein the one or more processors, to select the set of RLM reference signals, are configured to select RLM reference signals associated with a specified CORESET pool index.

9. The UE of claim 1, wherein the UE is configured with CORESETs of different CORESET pool indices, and wherein the one or more processors, to select the set of RLM reference signals, are configured to select RLM reference signals based at least in part on an associated CORESET pool identifier (ID), an associated CORESET ID, or an associated search space set ID.

10. The UE of claim 1, wherein the one or more processors, to select the set of RLM reference signals, are configured to select the set of RLM reference signals based at least in part on radio link quality.

11. The UE of claim 10, wherein a radio link quality for an RLM reference signal is assessed based at least in part on a pairing of the RLM reference signal with another reference signal.

12. A user equipment (UE) for wireless communication, comprising:
a memory; and
one or more processors, coupled to the memory, configured to:
select a set of radio link monitoring (RLM) reference signals according to a rule for selecting the set of RLM reference signals from among RLM reference signals that are quasi-colocated (QCLed) with active transmission control indicator (TCI) states for physical downlink control channel (PDCCH) communications in control resource sets (CORESETs), wherein at least one of the PDCCH communications is to be monitored in two linked search space (SS) sets associated with two CORESETs of the CORESETs; and
monitor for the set of RLM reference signals.

13. The UE of claim 12, wherein the set of RLM reference signals is a proper subset of the RLM reference signals that are QCLed with active TCI states in the CORESETs.

14. The UE of claim 12, wherein the CORESETs are used in a non-single frequency network, and wherein the rule specifies selection from among RLM reference signals associated with CORESETs that are not associated with PDCCH repetition.

15. The UE of claim 12, wherein the CORESETs are used in a non-single frequency network, and wherein the rule specifies selection from among RLM reference signals associated with CORESETs that are associated with PDCCH repetition.

16. The UE of claim 12, wherein the one or more CORESETs are used in a non-single frequency network, and wherein the rule specifies selection from among RLM reference signals associated with all of the CORESETs.

17. The UE of claim 12, wherein the one or more CORESETs are used in a non-single frequency network, and wherein the rule specifies selecting either RLM reference signals not associated with PDCCH repetition or one RLM reference signal associated with CORESETs associated with PDCCH repetition.

18. The UE of claim 17, wherein one RLM reference signal associated with CORESETs associated with PDCCH repetition is selected based at least in part on a TCI state identifier or a reference signal periodicity.

19. A user equipment (UE) for wireless communication, comprising:
a memory: and
one or more processors, coupled to the memory, configured to:
select a set of radio link monitoring (RLM) reference signals according to a rule for selecting the set of RLM reference signals from among RLM reference signals that are quasi-colocated (QCLed) with active transmission control indicator (TCI) states for physical downlink control channel (PDCCH) communications in control resource sets (CORESETs), wherein at least two of the RLM reference signals that are QCLed with active TCI states in CORESETs are associated with PDCCH repetition, and wherein the at least two of the RLM reference signals are associated with search space (SS) sets having a same monitoring periodicity: and
monitor for the set of RLM reference signals.

20. The UE of claim 19, wherein the set of RLM reference signals is a proper subset of the RLM reference signals that are QCLed with active TCI states in the CORESETs.

21. The UE of claim 19, wherein the one or more processors are configured to prioritize, for selection, RLM reference signals associated with SS sets in decreasing order of monitoring periodicity.

22. The UE of claim 19, wherein the one or more processors are configured to prioritize, for selection, RLM reference signals associated with SS sets in increasing order of monitoring periodicity.

23. The UE of claim 19, wherein the one or more processors are configured to prioritize, for selection, RLM reference signals associated with SS sets in an order according to a scaled effective periodicity.

24. A base station for wireless communication, comprising:
a memory; and
one or more processors, coupled to the memory, configured to:
generate an indication of a set of radio link monitoring (RLM) reference signals that a user equipment (UE) is to monitor from among RLM reference signals that are quasi-colocated (QCLed) with active transmission control indicator (TCI) states for physical downlink control channel (PDCCH) communications in control resource sets (CORESETs), wherein at least one of the PDCCH communications is associated with at least two active TCI states: and
transmit the indication to the UE.

25. The base station of claim 24, wherein the indication is transmitted in a radio resource control message or a medium access control control element (MAC-CE), and wherein at least one of the RLM reference signals in the set of RLM reference signals is part of a pair of channel state information reference signals or a pair of synchronization signal blocks.

26. The base station of claim 24, wherein the indication is transmitted in a radio resource control message or a medium access control control element (MAC-CE), and wherein none of the set of RLM reference signals is part of a pair of channel state information reference signals or a pair of synchronization signal blocks.
